(19) United States
(12) Patent Application Publication
(10) Pub. No.: US 2022/0269281 A1
(43) Pub. Date: Aug. 25, 2022

(54) METHOD AND SYSTEM FOR GENERATING A TOPOLOGICAL GRAPH MAP

(71) Applicants: Ran CHENG, Markham (CA); Yuan REN, Thornhill (CA); Bingbing LIU, Markham (CA)

(72) Inventors: Ran CHENG, Markham (CA); Yuan REN, Thornhill (CA); Bingbing LIU, Markham (CA)

(21) Appl. No.: 17/182,935

(22) Filed: Feb. 23, 2021

(51) Int. Cl. G05D 1/02

(52) U.S. Cl. CPC G05D 1/0251; G05D 1/0278; G05D 1/0212; G05D 2201/0213

(57) ABSTRACT

A system and method for generating a topological road map are disclosed, the method may include: receiving a plurality of Global Positioning System (GPS) positions representing a travelled path of a vehicle, each GPS position being associated with a respective timestamp; receiving a plurality of three-dimensional (3D) point clouds, each of the plurality of 3D point clouds being a corresponding 3D point cloud of a respective GPS position from the plurality of GPS positions; generating plurality of road parts based on the plurality of GPS positions; generating a map for each of the plurality of road parts based on at least one 3D point cloud from the plurality of 3D point clouds; and generating the topological road map based on the map for each of the plurality of road parts.

### REFERENCE TO RELATED APPLICATIONS

This is the first application for this disclosure.

### FIELD

The present disclosure relates to generating maps for autonomous driving. Specifically, the present disclosure relates to generating topological graph maps using three-dimensional (3D) point clouds and Global Positioning System (GPS) data for autonomous driving.

### BACKGROUND

An autonomous vehicle may include different types of sensors, such as a camera, a scanning light detection and ranging (LIDAR) sensor, and a radar to sense an environment surrounding the vehicle, and may process sensor data received from each of the different types of sensors of the vehicle to detect objects (e.g., pedestrians or other cars) in the environment surrounding the vehicle. An autonomous vehicle also includes an automated driving system (ADS) which autonomously or semi-autonomously controls operation of the vehicle based on information obtained from the different types of sensors.

An ADS may use a three-dimensional (3D) map to perform various tasks for the autonomous vehicle, such as vehicle localization, path planning, motion planning, and trajectory generation. However, 3D maps are often high-definition in nature and processing 3D maps when performing a task for an autonomous vehicle typically requires a large amount of Random Access Memory and processing power, which makes processing a 3D map on a computing system of an autonomous vehicle suboptimal because such a computing system generally has a limited amount of memory and processing power. On the other hand, processing 2D voxelized maps generated from point clouds, requires less memory and processing power than required for processing 3D maps. However, 2D maps, such as 2D voxelized maps, cannot adequately represent vertically overlapping structures, e.g., an indoor garage. Moreover, performing various tasks, such as vehicle localization using 2D voxelized maps may require constant real-time GPS measurements, which can be unavailable when the GPS signal is blocked or weak, leading to potential safety issues.

There is a need for an improved solution that can generate a relatively lightweight 3D map which can be processed by a computing system of an autonomous vehicle to perform various tasks, such as vehicle localization, path planning, motion planning, and trajectory generation.

### SUMMARY

The present disclosure provides methods and systems for generating a topological graph map for use by an automated driving system of an autonomous vehicle for various tasks, such as vehicle localization, path planning, motion planning, and trajectory generation. In example embodiments, the method and system of the present disclosure generates a topological graph map directly from 3D point clouds observed during a survey and GPS positions taken along a road path travelled. The topological graph map, after being generated, can be downloaded and stored in storage of a computing system of an autonomous vehicle either before the autonomous vehicle is deployed (e.g., put on the road), or downloaded using a wireless connection when the autonomous vehicle is operating autonomously or semi-autonomously. The topological graph map may be used by an automated driving system of the autonomous vehicle to perform one or more tasks, such as vehicle localization, path planning, motion planning, and trajectory generation. The topological graph map can be represented using maps for road parts as nodes and connections between the road parts as edges, which allows a processor of a computing system of the autonomous vehicle to quickly load each road part dynamically into memory of the computing system for processing. This is in contrast to conventional 3D maps which are stored in storage of the computing system of the autonomous vehicle as tiles and loaded by the processor into memory of the computing system of the autonomous vehicle by constantly query stored tiles of a map stored in storage of the computing system using GPS signals.

The topological graph map can distinguish multi-level building or structures because vertically overlapping road segments are not connected as adjacent nodes in the graph. Furthermore, the topological graph map can be easily expanded or otherwise edited, due to its unique file format.

A first aspect of the present disclosure provides a computer-implemented method for generating a topological graph map. The computer-implemented method includes receiving a plurality of Global Positioning System (GPS) coordinates representing a plurality of locations of a vehicle along a travelled path, each of the plurality of GPS positions representing a respective location from the plurality of locations and associated with a respective timestamp, receiving a plurality of three-dimensional (3D) point clouds, each of the plurality of 3D point clouds being a corresponding 3D point cloud of a respective GPS position from the plurality of GPS positions and captured at each time the respective GPS position is captured, and generating a plurality of road parts based on the plurality of GPS positions, wherein each of the one or more road parts is associated with at least one GPS position from the plurality of GPS position. The computer-implemented method also includes generating a map for each of the plurality of road parts based on at least one 3D point cloud from the plurality of 3D point clouds; and generating the topological graph map based on the map for each of the plurality of road parts; the topological graph map including a plurality of edges and a plurality of nodes, where each node represents a respective road part from the plurality of road parts and each edge represents a connection between two road parts from the plurality of road parts.

Generating the plurality of road parts may include determining a plurality of pivotal points of the travelled path based on the plurality of GPS positions, the plurality of pivotal points including one or more curvature pivotal points and one or more elevation pivotal points, and determining the plurality of road parts based on the one or more pivotal points.

Determining the plurality of pivotal points may include computing one or more curvature values based on the plurality of GPS positions; determining one or more peak curvatures based on the one or more curvature values, and selecting the one or more peak curvatures above a curvature threshold to be the one or more curvature pivotal points.

Determining plurality of pivotal point may include determining the one or more elevation pivotal points may include finding local maximum and minimum elevation values based on one or more of the plurality of GPS positions.

Determining the plurality of road parts may include computing a respective distance between one or more pairs of adjacent pivotal points from the plurality of pivotal points, the adjacent pivotal points including both curvature and elevation pivotal points, selecting one or more road segments based on the respective distance between each pair of the one or more pairs of adjacent pivotal points; and filtering the one or more road segments to obtain the plurality of road parts.

Filtering the one or more road segments may include selecting the one or more road segments based on a minimum distance threshold.

The computer-implemented method may include generating one or more road intersections based on the one or more one or more road segments.

The computer-implemented method may include: generating the plurality of nodes based on the maps for the plurality of road parts; and generating the plurality of edges based on the one or more road intersections, each road intersection connecting a pair of two road parts from the plurality of road parts.

Generating the map for the road part based on at least one 3D point cloud from the plurality of 3D point clouds may include: retrieving a corresponding 3D point cloud for each GPS position from the at least one GPS position associated with the road part; and generating the map for the road part based on the corresponding 3D point cloud for each GPS position from the at least one GPS position.

A second aspect of the present disclosure provides a system for generating a topological graph map, the system includes a processing unit and a memory coupled to the processing unit, the memory storing machine-executable instructions that, when executed by the processing unit, cause the system to: receive a plurality of Global Positioning System (GPS) coordinates representing a plurality of locations of a vehicle along a travelled path, each of the plurality of GPS positions representing a respective location from the plurality of locations and associated with a respective timestamp; receive a plurality of three-dimensional (3D) point clouds, each of the plurality of 3D point clouds being a corresponding 3D point cloud of a respective GPS position from the plurality of GPS positions and captured at each time the respective GPS position is captured; generate plurality of road parts based on the plurality of GPS positions, wherein each of the plurality of road parts is associated with at least one GPS position from the plurality of GPS positions; generate a map for each of the plurality of road parts based on at least one 3D point cloud from the plurality of 3D point clouds; and generate the topological graph map based on the map for each of the plurality of road parts, the topological graph map comprising a plurality of edges and a plurality of nodes, wherein each node represents a respective road part from the plurality of road parts and each edge represents a connection between two road parts from the plurality of road parts.

The instructions, when executed by the processing unit, may cause the system to: determine a plurality of pivotal points of the travelled path based on the plurality of GPS positions, the plurality of pivotal points including one or more curvature pivotal points and one or more elevation pivotal points; and determine the plurality of road parts based on the one or more pivotal points.

The instructions, when executed by the processing unit, may cause the system to: compute one or more curvature values based on the plurality of GPS positions; determine one or more peak curvatures based on the one or more curvature values; and select the one or more peak curvatures above a curvature threshold to be the one or more curvature pivotal points.

The instructions, when executed by the processing unit, may cause the system to: find local maximum and minimum elevation values based on one or more of the plurality of GPS positions.

The instructions, when executed by the processing unit, may cause the system to: compute a respective distance between one or more pairs of adjacent pivotal points from the plurality of pivotal points, the adjacent pivotal points including both curvature and elevation pivotal points; select one or more road segments based on the respective distance between each pair of the one or more pairs of adjacent pivotal points; and filter the one or more road segments to obtain the plurality of road parts.

Filtering the one or more road segments may include selecting the one or more road segments based on a minimum distance threshold.

The instructions, when executed by the processing unit, may cause the system to generate one or more road intersections based on the one or more one or more road segments.

The instructions, when executed by the processing unit, may cause the system to: generate the plurality of nodes based on the maps for the plurality of road parts; and generate the plurality of edges based on the one or more road intersections, each road intersection connecting a pair of two road parts from the plurality of road parts.

The instructions, when executed by the processing unit, may cause the system to generate the map for the road part based on at least one 3D point cloud from the plurality of 3D point clouds by: retrieve a corresponding 3D point cloud for each GPS position from the at least one GPS position associated with the road part; and generate the map for the road part based on the corresponding 3D point cloud for each GPS position from the at least one GPS position.

The instructions, when executed by the processing unit, may cause the system to compress corresponding 3D point cloud for each GPS position from the at least one GPS position into a Portable Graphics Format (PNG) image to generate a node of the plurality of nodes in the topological graph map.

### BRIEF DESCRIPTION OF THE DRAWINGS

Reference will now be made, by way of example, to the accompanying drawings which show example embodiments of the present application, and in which:

FIG. 1 is a block diagram illustrating some components of an example autonomous vehicle.

FIG. 2 is a block diagram illustrating example processes performed by a computer system for generating a topological graph map, in accordance with some example embodiments.

FIG. 3 illustrates a process for extracting various pivotal points from a plurality of GPS positions in the process of generating a topological graph map, in accordance with some example embodiments.

FIG. 4A illustrates curvature based partition in the process of generating a topological graph map, in accordance with some example embodiments.

FIG. 4B illustrates road intersections in the process of generating a topological graph map, in accordance with some example embodiments.

FIG. 5A shows an example path that may be converted to a topological graph map, in accordance with some example embodiments.

FIG. 5B shows the first order derivative of the path in FIG. 5A.

FIG. 5C shows the second order derivative of the path in FIG. 5A.

FIG. 6 illustrates an example process of generating a topological graph map, in accordance with some example embodiments.

FIG. 7 illustrates an example topological graph map and a corresponding file format, in accordance with some example embodiments.

FIG. 8 illustrates an example road part merging process in the process of generating a topological graph map, in accordance with some example embodiments.

FIG. 9 illustrates an example process of merging road parts in an intersection, in the process of generating a topological graph map, in accordance with some example embodiments.

FIG. 10 illustrates an example large scale topological graph map, in accordance with some example embodiments.

FIG. 11 illustrates an example data key of a node saved in a csv file which may be used to store a number of information for each road part in the topological graph map.

Similar reference numerals may have been used in different figures to denote similar components.

### DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although they are illustrated separately for ease of explanation herein. Different devices may have different designs, such that although some devices implement some functions in fixed function hardware, other devices may implement such functions in a programmable processor with code obtained from a machine readable medium.

Current map formats for use by autonomous vehicles have a number of limitations. For example, city-scale 3D maps are often high definition and large in size and thus difficult to process in real time as a vehicle navigates the road due to the limitations in memory and computing power of computing systems aboard autonomous vehicles. Existing 2D voxelized maps may not have all the boundary information regarding land markers which may lead to potential errors in the location of the vehicle when performing vehicle localization. Additionally, existing 2D voxelized maps cannot accurately represent multi-layer elements or structures in a map, such as overlapping bridges or a multi-story garage building.

The present invention provides a system and method for generating a topological graph map directly from 3D point clouds and GPS positions of the vehicle captured by sensors of a vehicle as a vehicle travels along a path in an environment. The topological graph map may be a compact representation of places, roads and routes in the environment. Compared with city-scale 3D maps, the topological graph map generated by the systems and methods of the present disclosure can be stored in memory of a computing system of a vehicle, such as a vehicle controller, before the vehicle is used for autonomous operation, or downloaded through a wireless communication network (e.g., a cellular data network) while the vehicle is operating autonomous (or semi-autonomously) on a road.

The topological graph map of the present disclosure can isolate the vertical overlapping roads (e.g. in a garage) and can be used to perform vehicle localization in complex road junctions. In comparison, existing 2D voxelized maps which only represent one layer of horizontal space, data points in a 3D point cloud which represent several layers of overlapping structures or roads are encoded into the one layer. Using an existing 2D voxelized map to perform vehicle localization may lead to potential errors in the location of the vehicle generated based on local landmarks in multi-story buildings.

The topological graph map generated by the systems and methods of the present disclosure can be easy to extend, as the topological graph map has a simple form of nodes and edges, where nodes are maps (or may include links to maps) generated based on road parts, and edges represents a connections between two road parts (or two nodes). A connection can be, for example, a road intersection between two road parts, which may include a cross intersection, a T intersection, a turn, or any other form of road intersection between two road parts. Additional information can be encoded into the graph map, the topological representation naturally aligns with the real-world road properties like road speed restrictions and road conditions.

An autonomous vehicle operating in an environment may use the topological graph map to perform a particular task, such as vehicle localization, path planning for the vehicle, motion planning for the vehicle, or trajectory generation for the vehicle.

The topological graph map can be taken as a graph to describe the current road network, and by connecting each road junctions with graph edges, the topological graph map can be easily loaded dynamically without constantly querying the GPS satellite in real time to determine whether to load new maps or not.

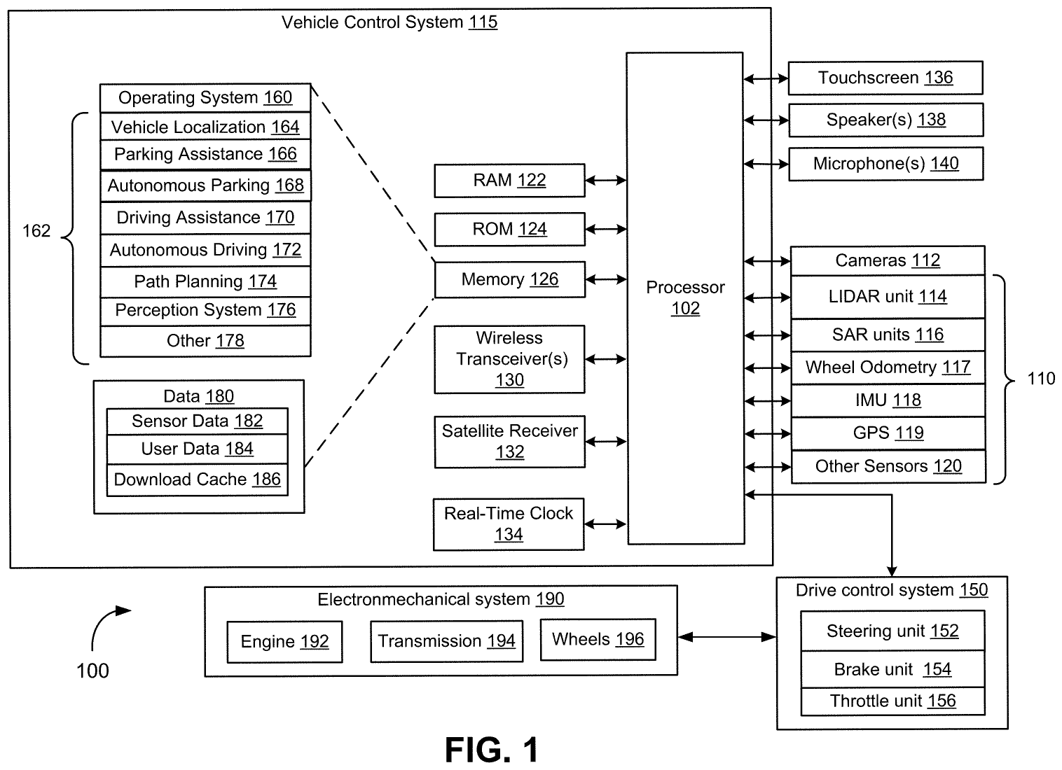

Referring to FIG. 1, an example of an autonomous vehicle 100 (hereinafter referred to as vehicle 100) that can be used to obtain the GPS positions along a travelled path of a vehicle and 3D point clouds that are used by a system and method of the present disclosure to generate a topology graph map and/or update an existing topological graph map is shown. The vehicle 100 uses the generated topological graph map for performing a task such as vehicle localization, path planning, motion planning, or trajectory generation.

The vehicle 100 may be any type of vehicle, such as a motor vehicle, such as a car, truck, bus, boat or ship, submarine, aircraft, warehouse equipment, construction equipment, tractor or other farm equipment. The vehicle 100 of the present disclosure is not limited to vehicles, or any particular type of vehicle, and may be a vehicle that does not carry passengers as well as a vehicle that carries passengers. The vehicle 100 may be a mobile robot including, but not limited to, autonomous vacuum cleaner, rover, lawn mower, unmanned aerial vehicle (UAV). The vehicle 100 described herein may operate in semi or fully autonomous mode, it can also be used for vehicles during non-autonomous driving mode

The vehicle 100 comprises sensors 110 for sensing an environment of the vehicle 110 (hereinafter referred to environmental sensors 110), sensors 111 for sensing operating parameters of the vehicle 100, such as speed, GPS position, orientation, and acceleration of the vehicle 100, a vehicle control system 115 that is connected to environmental sensors 110 and the sensors 111, a drive control system 150 and a mechanical system 190. The vehicle 100 also comprises various structural elements (not shown) such as a frame, doors, panels, seats, windows, mirrors and the like that are known in the art but that have been omitted from the present disclosure to avoid obscuring the teachings of the present disclosure. The environmental sensors 110 are mounted to structural elements of the vehicle 100 at various locations on the vehicle 100.

The vehicle control system 115 includes a processor 102 that is coupled to a plurality of internal components of the vehicle 100 via a communication bus (not shown). The processor 102 is coupled to a Random Access Memory (RAM) 122, Read Only Memory (ROM) 124, persistent (non-volatile) memory 126 such as flash erasable programmable read only memory (EPROM) (flash memory), one or more wireless transceivers 130 for exchanging radio frequency signals with a wireless network, a satellite receiver 132 for receiving satellite signals from a satellite network, a real-time clock 134. The vehicle control system 115 is also coupled to other components of the vehicle 100, including the environmental sensors 110 and sensors 111, a touchscreen 136, speaker(s) 138, microphone(s) 140, the drive control system 150, and the mechanical system 190.

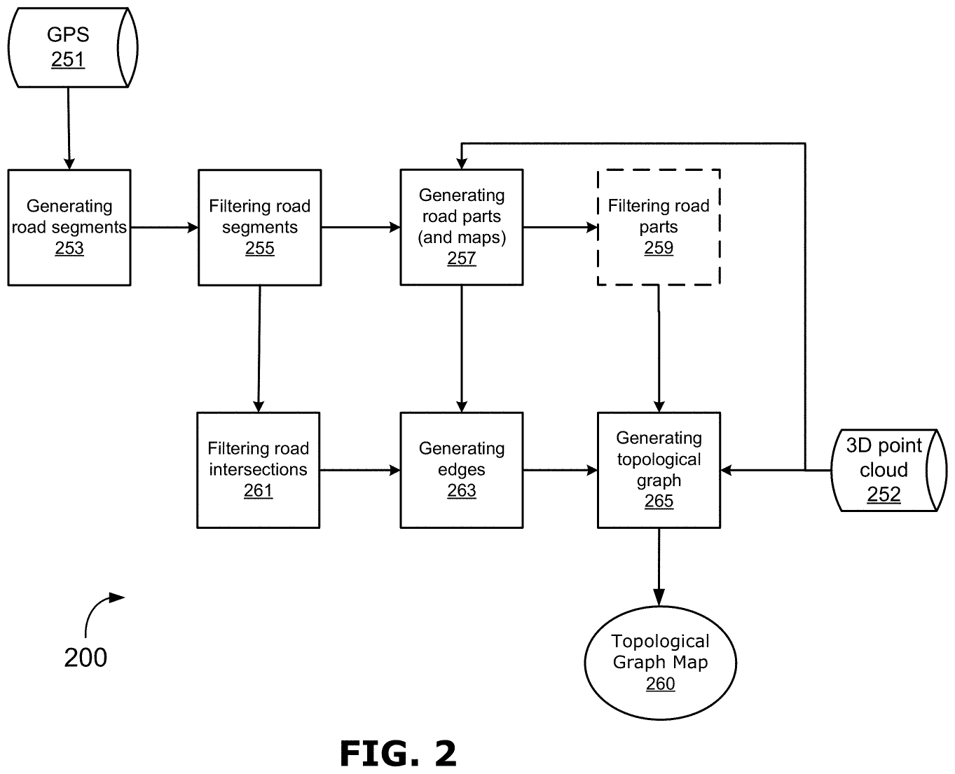

The one or more wireless transceivers 130 may be used to, when the vehicle 100 is in operation, to download a generated topological graph map 260 (see FIG. 2) for performing a task, such as vehicle localization, path planning, motion planning, and trajectory generation. The one or more wireless transceivers 130 may comprise one or more cellular (RF) transceivers for communicating with a plurality of different radio access networks (e.g., cellular networks) using different wireless data communication protocols and standards. The vehicle control system 115 may communicate with any one of a plurality of fixed transceiver base stations of a wireless WAN (e.g., cellular network) within its geographic coverage area. The one or more wireless transceiver(s) 130 may send and receive signals over a wireless WAN. The one or more wireless transceivers 130 may comprise a multi-band cellular transceiver that supports multiple radio frequency bands.

The one or more wireless transceivers 130 may also comprise a wireless local area network (WLAN) transceiver for communicating with a WLAN (not shown) via a WLAN access point (AP). The WLAN may comprise a Wi-Fi wireless network which conforms to IEEE 802.11x standards (sometimes referred to as Wi-Fi®) or other communication protocol.

The one or more wireless transceivers 130 may also comprise a short-range wireless transceiver, such as a Bluetooth® transceiver, for communicating with a mobile computing device, such as a smartphone or tablet. The one or more wireless transceivers 130 may also comprise other short-range wireless transceivers including but not limited to Near field communication (NFC), IEEE 802.15.3a (also referred to as Ultra Wideband (UWB)), Z-Wave, ZigBee, ANT/ANT+ or infrared (e.g., Infrared Data Association (IrDA) communication).

The real-time clock 134 may comprise a crystal oscillator that provides accurate real-time information, such as those provided by Atmel Corporation.

The touchscreen 136 comprises a display such as a color liquid crystal display (LCD), light-emitting diode (LED) display or active-matrix organic light-emitting diode (AMOLED) display, with a touch-sensitive input surface or overlay connected to an electronic controller. Additional input devices of the vehicle 100 (not shown) coupled to the processor 102 may also be provided including buttons, switches and dials.

The vehicle control system 115 also includes one or more speakers 138, one or more microphones 140 and one or more data ports 142 such as serial data ports (e.g., Universal Serial Bus (USB) data ports). The system may also include other sensors such as tire pressure sensors (TPSs), door contact switches, light sensors, proximity sensors, etc.

The drive control system 150 serves to control movement of the vehicle 100. The drive control system 150 comprises a steering unit 152, a brake unit 154 and a throttle (or acceleration) unit 156, each of which may be implemented as software modules or control blocks within the drive control system 150. The steering unit 152, brake unit 154 and throttle unit 156 process, when in fully or semi-autonomous driving mode, received path information from a path planning system 174 stored in the memory 126 of the vehicle control system 115 and generate control signals to control the steering, braking and throttle of the vehicle 100, respectively to drive a planned path. The drive control system 150 may include additional components to control other aspects of the vehicle 100 including, for example, control of turn signals and brake lights.

The mechanical system 190 receives control signals from the drive control system 150 to operate the mechanical components of the vehicle 100. The mechanical system 190 effects physical operation of the vehicle 100. The mechanical system 190 comprises an engine 192, a transmission 194 and wheels 196. The engine 192 may be a gasoline-powered engine, a battery-powered engine, a hybrid engine, an electric for example. Other components may be included in the mechanical system 190, including, for example, turn signals, brake lights, fans and windows.

A graphical user interface (GUI) may be rendered and displayed on the touchscreen 136 by the processor 102. A user may interact with the GUI using the touchscreen and optionally other input devices (e.g., buttons, dials) to display relevant information, such as navigation information, driving information, parking information, media player information, climate control information, etc. The GUI may comprise a series of traversable content-specific menus.

The memory 126 of the vehicle control system 115 has stored thereon operating system 160 and automated driving system (ADS) 162 for autonomously or semi-autonomously operating the vehicle 100. The ADS 162 generates control signals that are provided to the drive control system 150. The ADS 162 includes machine-readable instructions executable by the processor 102. The ADS 162 include vehicle localization subsystem 164, parking assistance subsystem 166, autonomous parking subsystem 168, driving assistance subsystem 170, path planning subsystem 174, perception subsystem 176, mapping subsystem 178, and other subsystems 181. Other subsystems 181 include for example climate control subsystem, media player subsystem, telephone subsystem and messaging subsystem, etc. are also stored in the memory 126.

Although shown as a separate software the parking assistance subsystem 166, autonomous parking subsystem 168, path planning subsystem 174, the perception subsystem 176, the mapping subsystem 178, or the other subsystems 178 may be combined with one or more of the other software subsystems in other embodiments. Also, although the vehicle 100 shown in FIG. 1 includes an ADS 162, in alternative embodiments, the vehicle 100 may include an advanced driver assist system (ADAS) that includes one or more the subsystems 164, 166, 168, 170, 172, 176, 178, and 180 described above.

The memory 126 also stores a variety of data 180. The data 180 may comprise sensor data 182 received from the sensors of the sensors 110, 111, user data 184 comprising user preferences, settings and optionally personal media files (e.g., music, videos, directions, etc.), and a download cache 186 comprising data downloaded via the wireless transceivers 130. The sensor data 182 may include image data received from the cameras 112, three-dimensional point clouds received from the LIDAR sensor 114, radar data received from the radar sensor 116, odometry data received from the wheel odometer 117 and/or an inertial measurement unit (IMU) 118, location data from global positioning system (GPS) sensor 119, and data from other sensors 120. The odometry data received from the wheel odometer 117 includes rotation data indicative of rotation of the wheels of the vehicle 100 and translation data indicative of a translation of the vehicle 100. The odometry data received from the IMU 118 includes three-axis angular velocity of the vehicle 100 and three-axis acceleration of the vehicle 100.

The LIDAR sensor 114 may be a scanning LIDAR sensor that captures information in a wide view (e.g., 360° view) about the vehicle 100. The LIDAR sensor 114 captures three-dimensional (3D) information about the environment, and generates a three dimensional (3D) point cloud. A point cloud is dataset that represents objects or space. A 3D point cloud includes a set of data points in 3D coordinate system of the scanning LIDAR sensor. It will be appreciate that other types of detection and ranging (DAR) sensors may generate a three-dimensional (3D) point cloud.

The environmental sensors 110, including the camera 112, LIDAR sensor 114, radar sensor 116 may collect information about the local external environment of the vehicle 100 (e.g., any immediately surrounding obstacles) as well as information from a wider vicinity (e.g., the LIDAR sensor 114 may collect information from an area of up to 100-meter radius or more around the vehicle 100). The sensors 111 may collect information about the position and orientation of the vehicle 100 relative to a frame of reference (e.g., using the GPS sensor 119).

The sensors 110, 111 communicate with the perception subsystem 176 via the processor 102 to provide sensor data 182, including a 3D point cloud received from the LIDAR sensor 114 to the perception system 176, which has been implemented to perform sematic segmentation on the 3D point cloud to generate a 3D semantic point cloud for use by other subsystems of the ADS 162, such as the vehicle localization subsystem 164, the planning subsystem 174 or the mapping subsystem 178. Each data point in the 3D semantic point cloud generated by the perception system 176 includes a class label, such as a pedestrian, building, tree, pole, or another car. The perception subsystem 176 may use any suitable method to perform semantic segmentation on a 3D point cloud.

The download cache 186 may be deleted periodically, for example, after a predetermined amount of time. System software, software modules, specific device applications, or parts thereof, may be temporarily loaded into a volatile store, such as RAM 122, which is used for storing runtime data variables and other types of data or information. Data received by the vehicle control system 115 may also be stored in the RAM 122. Although specific functions are described for various types of memory, this is merely one example, and a different assignment of functions to types of memory may also be used.

The vehicle control system 115 also includes a satellite receiver 132 that may use signals received by a satellite receiver from a plurality of satellites in a satellite network to determine its position. The satellite network typically comprises a plurality of satellites which are part of at least one Global Navigation Satellite System (GNSS) that provides autonomous geo-spatial positioning with global coverage. For example, the satellite network may be a constellation of GNSS satellites. Example GNSSs include the United States NAVSTAR Global Positioning System (GPS) or the Russian Global NAvigation Satellite System (GLONASS). Other satellite navigation systems which have been deployed or which are in development include the European Union's Galileo positioning system, China's BeiDou Navigation Satellite System (BDS), the Indian regional satellite navigation system, and the Japanese satellite navigation system.

The vehicle 100 may include other components that are not shown, including, for example, a user interface system and a wireless communication system (e.g., including an antenna). These other components may also provide input to and/or receive output from the above-described systems. The vehicle 100 may communicate with an external system, for example an external map database. The vehicle 100 may also communicate with a network, for example a vehicle network that enables communication among autonomous, semi-autonomous or non-autonomous vehicles.

The vehicle 100 can generate 3D point clouds and GPS positions as the vehicle 100 travels along a planned path and provide the 3D point cloud and the GPS positions to a computing system for generation of a topological graph map. The topological graph map includes nodes and edges, where nodes are maps (or may include links to maps) generated based on road parts, and edges represents a connections between two road parts (or two nodes). A connection can be, for example, a road intersection between two road parts, which may include a cross intersection, a T intersection, a turn, or any other form of road intersection between two road parts. The maps and edges can be generated based on the 3D point clouds and GPS positions along the planned path. The topological graph map can be easily loaded dynamically in contrast to conventional maps which are loaded by constantly querying the GPS satellite in real time to obtain a GPS position and to determine whether or not to load a new map based on the GPS position.

The generated topological graph map can isolate the vertical overlapping roads (e.g. in a garage) and support localization in complex road junctions. In comparison, a 2D voxelized map only represents one layer of horizontal space: data points in a 3D point cloud representing several layers of overlapping structures or roads are encoded into the map layer. Using such a 2D voxelized map may to potential localization errors by the ADS 162, which may perform vehicle localization based on local landmarks in multi-story buildings.

The generated topological graph map can be easily extended, as the map has a simple form of nodes and edges, where nodes represent road parts and edges represent connections between the road parts (e.g., road intersections). Additional information can be encoded into the topological graph map, the topological representation naturally aligns with the real-world road properties like road speed restrictions and road conditions.

FIG. 2 shows a block diagram illustrating example process 200 for generating a topological graph map 260. The process 200 may be performed by a computer system, which may be, for example, a standalone computer server, one or more physical machines (e.g. servers) of a datacenter, one or more virtual machines provided by cloud computing system, or a mapping service provided by a cloud computing provider. In some embodiments, the process 200 may be performed by the vehicle controller 115 of the vehicle 100. The process 200, when performed by a computing system, generates and/or updates a topological graph map 260 based on a set of GPS positions 251 and 3D point clouds 252. Execution of process 200 by a computing system may include performing various actions, operations, or sub processes as described in detail below.

The computer system may include a processing unit and a memory coupled to the processing unit; the memory may store machine-executable instructions of the process 200 which when executed by the processing unit, cause the computing system to receive: a plurality of GPS positions 251 representing a travelled path of a vehicle 100 and a plurality of 3D point clouds 252. Each of the plurality of GPS positions 251 is associated with a respective timestamp, and each of the plurality of 3D point clouds is a corresponding 3D point cloud of a respective GPS position from the plurality of GPS positions 251, where the corresponding 3D point cloud of a GPS position from the plurality of GPS positions shares the same timestamp with the respective GPS position from the plurality of GPS positions 251.

In some embodiments, each GPS position may be include a set of coordinates, (x, y, z) coordinates, and may include a respective latitude value represented by the x coordinate, a respective longitude value represented by the y coordinate, and a respective altitude value represented by the z coordinate.

In some embodiments, each GPS position may be represented as a set of coordinates, (x, y, z) coordinates, in the Universal Transverse Mercator (UTM) system, and may include a respective east value represented by the x coordinate, a respective north value represented by the y coordinate, and a respective elevation value represented by the z coordinate.

Generally, each point in a 3D point cloud 252 may be represented as a vector containing values of 3D Cartesian coordinates in a frame of reference of the LIDAR sensor 114, and optionally other values (e.g., additional information such as an intensity of reflected light, or time of firing and detection). For example, the Cartesian coordinate system used by a LIDAR sensor 114 on the vehicle 100 generally uses the center of the LIDAR sensor 114 as the origin point, with x axis pointing to the direction of driving, y axis points to the left side of the direction of driving and the z axis points vertically upward. A 3D point cloud 252 corresponds to a 360° scan of a physical environment surrounding the vehicle 100 by the LIDAR sensor 114.

The process 200 may first generate plurality of road parts based on the plurality of GPS positions 251 representing a travelled path of a vehicle 100, where each of the plurality of road parts is associated with at least one GPS position from the plurality of GPS positions along the travelled path of the vehicle 100. The process 200 then may generate a map for each of the plurality of road parts based on at least one 3D point cloud from the plurality of 3D point clouds 252, and further generate a topological graph map 260 including nodes and edges, where each node is the map (or may include a link to the map) generated for each of the plurality of road parts and each edge represents an road intersection connecting two road parts from the plurality of road parts.

The process 200 first performs a sub process 253 to generate road segments based on the plurality of GPS positions 251 of the travelled path of the vehicle 100. In some embodiments, the generation of road segments may include determining a plurality of pivotal points based on the plurality of GPS positions 251, the one or more pivotal points including one or more curvature pivotal points and one or more elevation pivotal points, generating a respective distance between one or more pairs of adjacent pivotal points from the plurality of pivotal points, and then generating one or more road segments based on the respective distance between each pair of the one or more pairs of adjacent pivotal points. A sub process 255 of the process 200 is then performed by the process 200 to filter the road segments generated by the sub process 253, which may include selecting one or more road segments based on a minimum distance threshold.

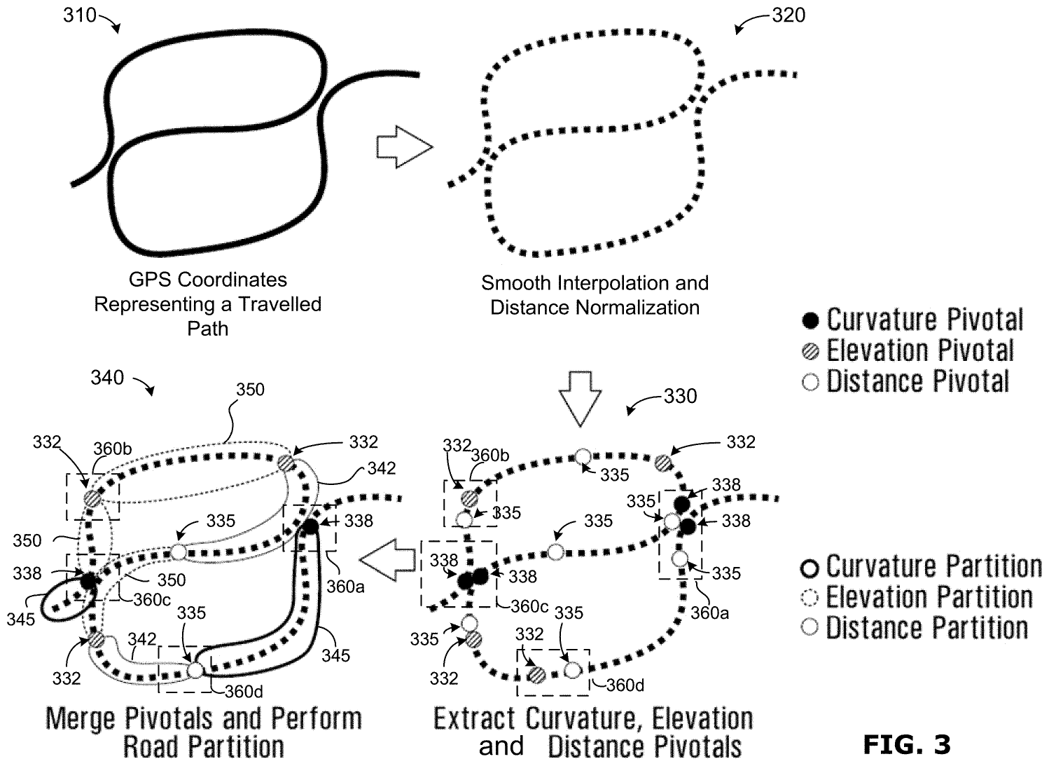

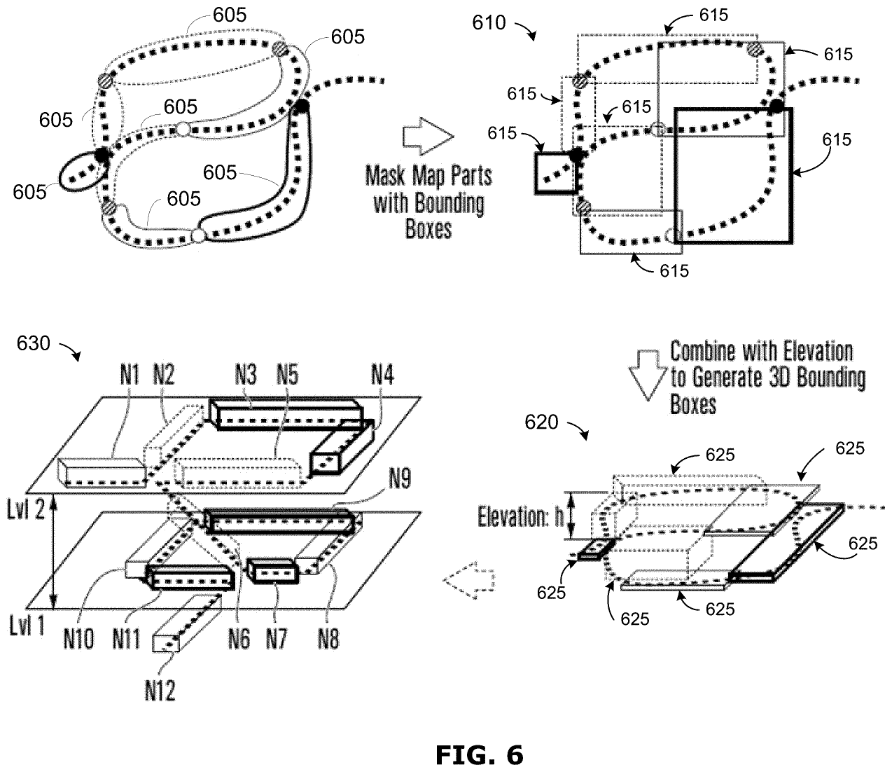

A sub process 257 of the process 200 is then performed to generate road parts based on the filtered road segments generated by the sub process 255, based on part of a process described in detail with reference to FIG. 3 below. The sub process 257 may also retrieve one or more 3D point clouds 252 corresponding to the GPS positions 251 for a road part, and generate a map based on the 3D point clouds 252 associated with the road part, in accordance with a process described in detail with reference to FIG. 6 below. Each map may be stored as an image (e.g. a PNG image) and stored in association with a node of the final topological graph map 260.

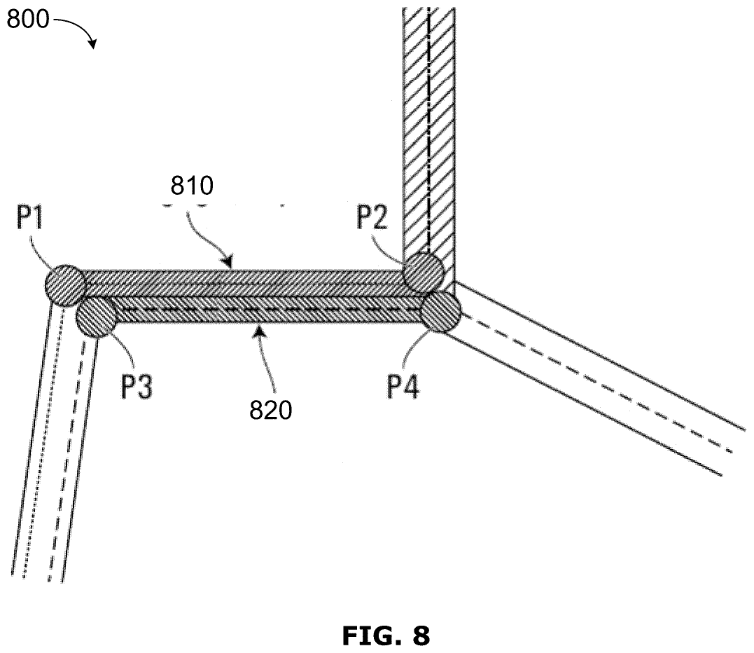

A sub process 259 of the process 200, which can be an optional process, can be configured to filter the road parts from the sub process 257 to generate filtered road parts. For example, the sub process 259 may remove redundant road parts that are too close together, in accordance with a process described in detail with reference to FIG. 8 below.

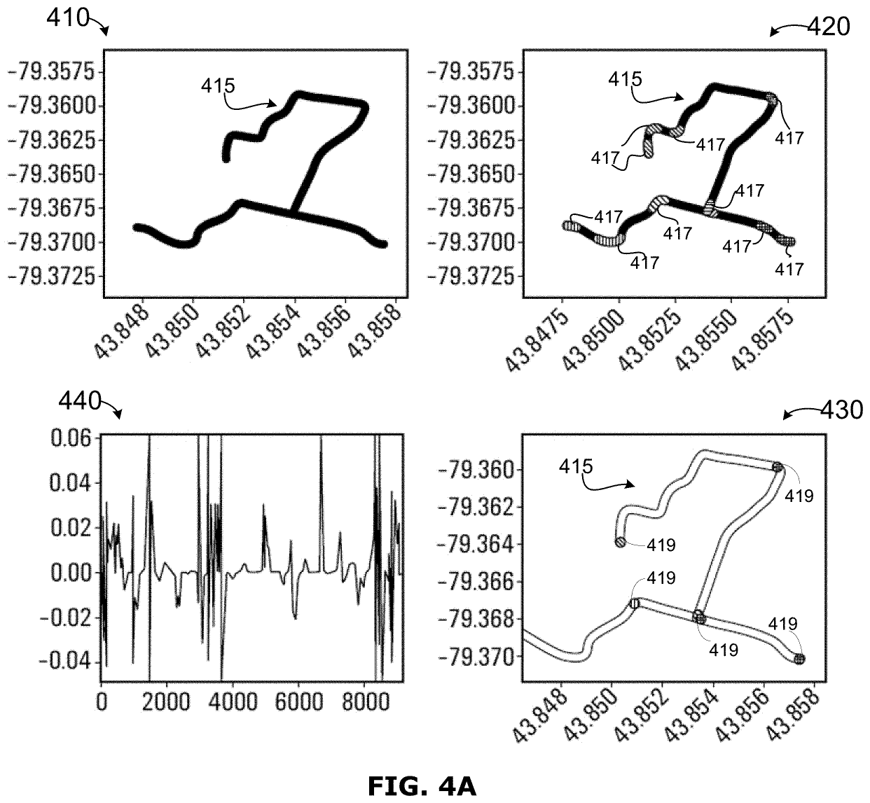

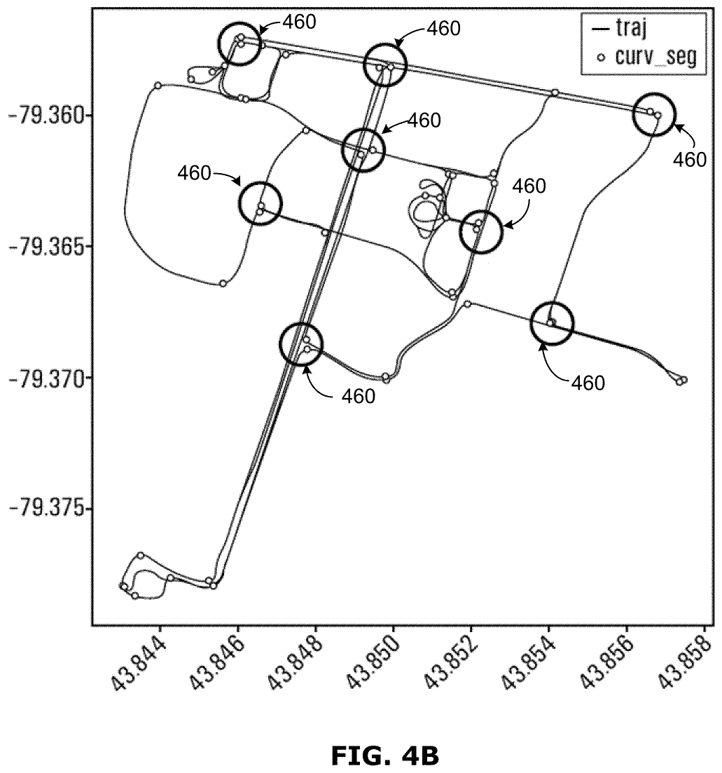

A sub process 261 of the process 200 is then performed to generate filtered road intersections from the filtered road segments output by sub process 255, based on a process described in detail with reference to FIG. 4B below, in which peak curvature pivotal points are processed to generate the filtered road intersections.

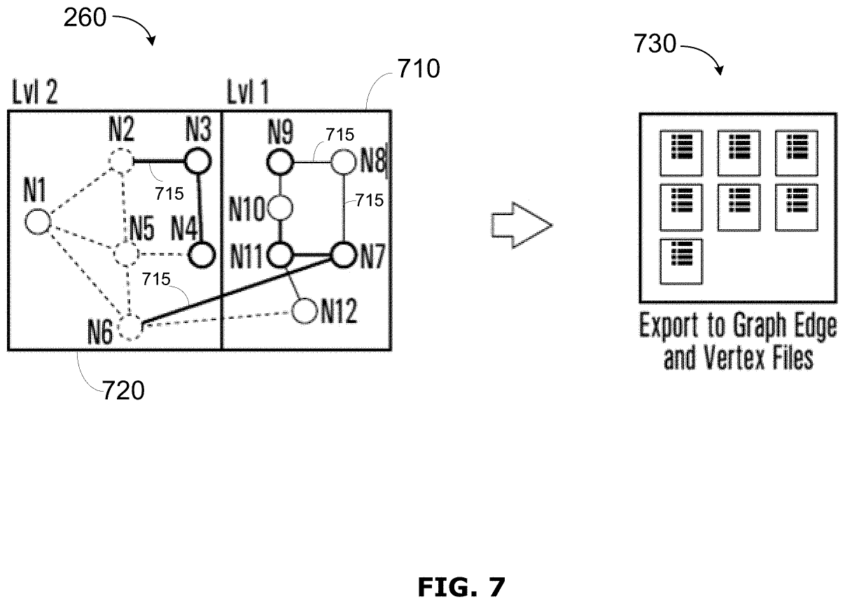

A sub process 263 of the process 200 then generate edges for a topological graph based on the filtered road intersections output from sub process 261 and the maps generated based on the road parts from the sub process 257, in accordance with a process described in detail with reference to FIG. 7 below, each edge represents a connection between two road parts (or two nodes), as generated by the sub process 257.

A sub process 265 of the process 200 is then performed to generate the topological graph map 260 based on the edges of the graph generated by the sub-process 263 and the maps generated by the sub-process 257, which may be filtered by sub-process 259. Each road part from the sub process 257 may be used to generate a map that may be stored as a node of the topological graph map 260. Each edge represents a connection between two road parts (or two nodes), as generated by the sub process 257. A connection can be can be, for example, a road intersection between two road parts, which may include a cross intersection, a T intersection, a turn, or any other form of road intersection between two road parts.

FIG. 3 illustrates a process for extracting various pivotal points based on the GPS positions in the process of generating a topological graph map 260, in accordance with some example embodiments. The process shown in FIG. 3 correspond to sub-processes 253, 255, 257, 259 and 261. At 310, a plurality of GPS positions 251 of a path travelled by the vehicle 100 that are received from the vehicle 100 are shown. The plurality of GPS positions 251 were captured by the GPS sensor 119 as the vehicle 100 travelled along the path. In some embodiments, the GPS positions 251 may be received in real-time from the vehicle 100 as the vehicle 100 travelled along the path.

The plurality of GPS positions 251 represent a path travelled by the vehicle 100, and may be stored in a memory storage device either locally, such as the memory 126 of the vehicle control system 115, or from a remote server that may wirelessly transmits the plurality of GPS positions 251 to the system performing process 200 shown in FIG. 2. Each GPS position 251 may be associated with a unique timestamp t. In addition, each GPS position 251 may be associated with a corresponding 3D point cloud having the same timestamp t.

In some embodiments, a GPS position from the plurality of GPS positions 251 may be represented in a matrix form, for example, a GPS position at timestamp tₙ may be represented as [xₙ yₙ zₙ tₙ]. The plurality of GPS positions 251 may be then represented as a matrix having N rows corresponding to the number of timestamps, with each row having a column [xₙ yₙ zₙ tₙ], where n is numbered from 1 to N, for a total of N GPS positions 251.

In some embodiments, the GPS positions 251 may be pre-processed. For example, the GPS positions 251 may be down-sampled according to the following distance function:

f(x, y, z)=ϕ(∥xₜ−xₜ₋₁, yₜ−yₜ₋₁, zₜ−zₜ₋₁∥)∀t∈N

where (x, y, z) represents the coordinates of a GPS position from the GPS positions 251, ø is a sampling function which determines a distance between two consecutive GPS positions which have (x, y, z) coordinates into the down sampled path if the distance is above threshold. This way, the GPS positions 251 may be pre-processed to a plurality of pre-processed GPS positions with a minimum distance.

An example sampling function ø can be, for example, selecting a given GPS positions if the distance between this GPS positions and the next GPS positions is above a minimum threshold. An example minimum threshold value may be, for example, 0.1 meter. In some embodiments, the minimum threshold may range from 0.1 meter to 0.5 meter, or to 1 meter if need be, depending on how may the GPS positions 251 are received for the travelled path.

The pre-processed GPS positions may take the form of a matrix S having N′ rows, where N′ is less than or equal to N, and each row of the matrix represents a GPS positions [x_{n′} y_{n′} z_{n′} t_{n′}], where n′ numbers from 1 to N′. As shown at 320, the matrix S may be, as an optional step, interpolated and normalized using a Cublic Spline interpolation to ensure the travelled path represented by the GPS positions is smooth enough for computing second order derivatives using the distance function:

d(r)=Σd_{g}(t₁, t₂),

$${d}_{g} ( {t}_{1} , {t}_{2} ) = R arctan ( {sin ( \frac{dx}{2} )}^{2} + cos ( {y}_{1} ) cos ( {y}_{2} ) {sin ( \frac{dy}{2} )}^{2} )$$

where R is the radius of earth, t₁ and t₂ represent time t₁ and t₂, and x, y, z are the GPS positions in longitude and latitude form (i.e., using a UTM coordinate system), dx and dy are defined as, respectively, the horizontal and vertical directional gradient of the coordinates (x, y, z) of a GPS position, for example: dx=(xₜ₁−xₜ₂)/(t₁−t₂), and dy=(yₜ₁−yₜ₂)/(t₁−t₂).

In some embodiments, the column [t_{n′}] may be linearly interpolated separately.

As shown at 330, one or more curvature pivotal points 338, elevation pivotal points 332 and distance pivotal points 335 of the plurality of GPS positions 251 may be determined. In some embodiments, determining the one or more curvature pivotal points 338 may include: computing one or more curvature values based on the plurality of GPS positions 251; determining one or more peak curvatures based on the one or more curvature values; and selecting the one or more peak curvatures above a predefined curvature threshold to be one or more curvature pivotal points.

For example, computing the one or more first curvature values based on the matrix S may include:

$${crv}_{n} ( s ) = \frac{{d}_{x} {d}_{y}^{2} - {d}_{y} {d}_{x}^{2}}{{d}_{x}^{2} + {d}_{y}^{2}}$$

where dₓd_{y}²−d_{y}dₓ² control the sign of the curvature, a negative curvature indicate a left turn, and a positive curvature indicates a right turn.

In some embodiments, determining one or more peak curvatures based on the one or more first curvature values 338 may be based on the equation:

crvᵣ(s)=conv(abs(crvₙ(s)), gauss(σ, μ))

which is a function to smooth the curvature of travelled path S, σ and μ are, respectively, standard deviation and mean of a one-dimensional (1D) Gaussian distribution.

Pivotal points in S above a predefined high curvature value may be selected as curvature-based road segment candidates.

FIG. 4A illustrates curvature-based partitioning in the sub process 253 of the process 200 of generating a topological graph map 260, in accordance with some example embodiments. At 410, a travelled path (or simply “path”) based on GPS position 251 is shown. At 420, a plurality of GPS positions with high curvature values 417 are located. At 430, GPS positions with high curvature values 417 at various point clusters are merged such that only a single point with the highest curvature value 419 is selected as a curvature pivotal point. Graph 440 shows the second order derivative of each curvature value of the GPS positions with high curvature values 417.

In some embodiments, one or more road intersections may be generated based on the one or more one or more road segments from curvature pivotal points. FIG. 4B illustrates road intersections 460 generated by the sub process 261 of the process 200 of generating a topological graph map 260, in accordance with some example embodiments. Generally speaking, the more peak curvature pivotal points are clustered in a small region, the higher chance that the small region is a road intersection.

In some embodiments, selecting one or more peak curvature pivotal points above a curvature threshold to be one or more curvature pivotal points 338 may be based on the equation below:

$${p}_{i} = {e}^{- \frac{1}{{n}_{i} + {θ}_{i} + {ϕ}_{i}}}$$

where i denotes each peak curvature point, n is nearby curvature points, θ is distance to nearest altitude pivotal, ϕ is inverse distance of a previously selected curvature pivotal point 338.

The weight Pi in the equation above may be computed for each peak curvature point.

In some embodiments, determining the one or more elevation pivotal points 332 may include finding local maximum and minimum elevation values based on one or more of the plurality of GPS positions 251.

In some embodiments, an elevation pivotal point 332 may be determined by: obtaining the altitude value z from each processed GPS positions having (x, y, z) coordinates in the processed plurality of GPS positions 251 in the matrix form S; computing a gradient of all the altitude values for all the processed GPS positions; and computing the minimum and maximum values on the gradient to find the peak elevation pivotal points 332, where a peak elevation pivotal point 332 represent a GPS position with the most elevation change. For example, the second order derivative of a function representing the altitude values from the processed plurality of GPS positions may be computed, and zero-crossing points may be selected as the altitude segment candidates, since the second order derivative can capture the start point and end point of altitude changes, which may be, for example, entrance and exit of a bridge or slop, respectively.

In some embodiments, one or more distance pivotal points 335 may be determined based on the road parts length between any two adjacent points in the processed matrix S. For example, any road part length that is longer than a predefined distance threshold may be selected. The predefined distance threshold may be, for example, 200 meters.

Referring again to FIG. 3, at 340, the one or more curvature pivotal points 338, elevation pivotal points 332 and distance pivotal points 335 of the travelled path represented by the processed plurality of GPS positions may be merged. As can be seen from FIG. 3, when several pivotal points 332, 335, 338 are relatively close and form a cluster, a single point may be selected. For example, at point cluster 360a, two curvature pivotal points 338 and one distance pivotal point 335 are merged into a single curvature pivotal point 338. For another example, at point cluster 360b, one curvature pivotal point 338 and one distance pivotal point 335 are merged into a single curvature pivotal point 338. At point cluster 360c, two curvature pivotal points 338 are merged into a single curvature pivotal point 338. At point cluster 360d, one distance pivotal point 335 and one elevation point cluster 332 are merged into a distance pivotal point 335.

After merging the one or more curvature pivotal points 338, elevation pivotal points 332 and distance pivotal points 335, one or more road parts may be generated. For example, as shown in FIG. 3, elevation road part 350 may be formed between two elevation pivotal points 332, or between an elevation pivotal points 332 and a curvature pivotal point 338 or a distance pivotal point 335. Distance road part 342 may be formed between an elevation pivotal points 332 and a distance pivotal point 335. Curvature road part 345 may be formed between a curvature pivotal point 338 and another pivotal point.

In some embodiments, road parts may be determined by three factors: a curvature value which captures a road turn, an altitude value which captures the slopes in the road, and a distance value between the pivotal points selected according to the first two factors. Usually in an urban area, roads can be fragmented due to crossings, bridges or slopes. On a highway, roads can be relatively straight with very few curvature pivotal points, and each road part may be big.

A road segment may be a part of road between two pivotal points (e.g., curvature or altitude), and may be taken as a road part if the road segment is above a certain distance threshold (e.g., 200 meters). If a road segment is too short, the corresponding pivotal points on either end of the road segment may be skipped.

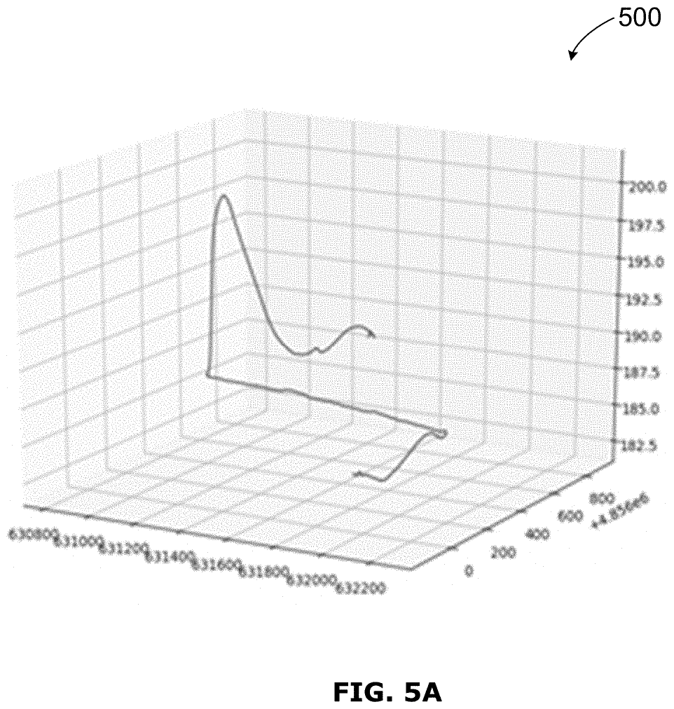

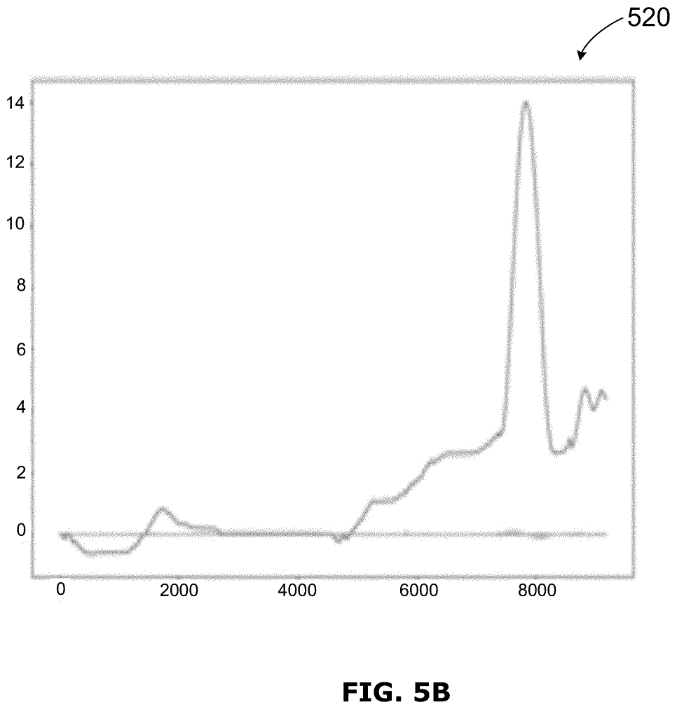

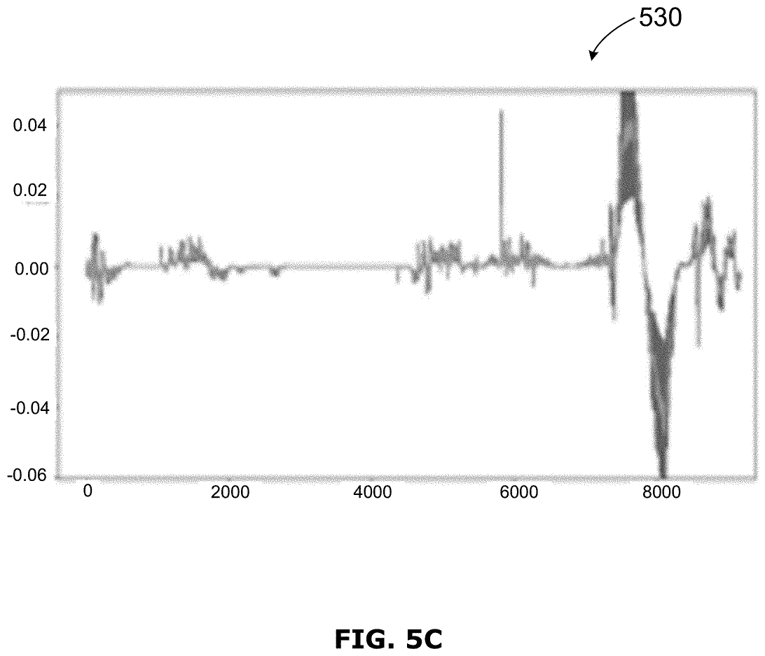

FIG. 5A shows an example of a plurality of GPS positions of a path 500 travelled by the vehicle 100 in 3D that may be used to generate a topological graph map 260. The path 500 may capture a bridge or a garage with winding roads with altitude changes. FIG. 5B shows the first order derivative 520 of the path 500 in FIG. 5A. FIG. 5C shows the second order derivative 530 of the 3D path in FIG. 5A. As illustrated in FIG. 5C, the second order of the altitude spline of the 3D path 500 captures the start point and end point of a bridge in FIG. 5A, and the zero-crossing points can capture the whole bridge part.

In some embodiments, a topological graph map 260 may be generated, in sub-process 257 and/or 265, based on the edges generated by sub-process 263 and a plurality of road parts generated by the sub-process 257 and/or 259. The topological graph map 260 includes one or more nodes and one or more edges, where a node represents a map for a road part from the plurality of road parts and an edge represents a connection between two road parts from the plurality of road parts. As mentioned earlier, each road part from the sub process 257 may be used to generate a map that may be stored as a node of the topological graph map 260. Each edge represents a connection between two road parts (or two nodes), as generated by the sub process 257. A connection can be can be, for example, a road intersection between two road parts, which may include a cross intersection, a T intersection, a turn, or any other form of road intersection between two road parts. The optional sub-process 259 may be used to filter one or more road parts or one or more maps from sub process 257. For instance, as a number of maps are generated for the plurality of road parts during sub process 257, there may be overlapped regions, these overlapping regions may be removed by sub process 259 to reduce data redundancy.

Turning now to the sub-process 265, sloping nodes may be obtained by first smoothing the altitude spline and then by finding maxima or minima of altitude gradient magnitude. The altitude spline is interpolated by cubic interpolation. As an example of smoothing the altitude spline, the altitude column in the previously filtered matrix S (N′ rows, 4 columns) may be interpolated by cubic interpolation and smoothed by Savitzky-Golay filter.

After the cubic interpolation step, sloping nodes may be located by finding maxima or minima of altitude gradient magnitude by finding zero-crossings based on the equation:

$$\frac{\partial {f}^{2}}{\partial {x}^{2}} ( x ) = 0$$

where x is the altitude spline.

By finding the zero-crossings, the start point and end point, i.e., sloping nodes can be located. In some embodiments, for a multi-layer indoor garage case, the gradient of altitude is just one peak, and the peak itself can be used to define both the start point and end point of the slope.

Next, all the road segment candidate points, which include curvature pivotal points, elevation pivotal points and distance pivotal points, may be merged by their weights and priorities. For example, all the road segment candidate points may be merged by their weights and priorities by arranging all the road segment candidate points into a list, and then road segment candidate points are ranked according to their weights, where weights are linear combination of priority and their own categorical weights based on the equation below:

$${w}_{p} = {n}_{n} + \frac{\sum d ( {n}_{n} )}{\sum d ( {n}_{n s e l} )}$$

where nₙ is number of neighbourhood candidates, and nₙₛₑₗ is the number of neighbourhood candidates that are already selected, and d( ) is the distance function described above.

The number of selected pivotal points may be initialized as zero, and in an iterative process, the top k pivotal points may be sampled from a list pivotal points that include pivotal points that are above a selected threshold, eventually the pivotal points will converge into a fixed size, which leads to road intersections.

In some embodiments, the weight of each pivotal point is affected by the following factors: a number of neighbor pivotal point, neighbor distance can be defined as, for example, 10 meters. The weight is also proportional to the sum distance of all the neighbor pivotal points and inverse proportional to the sum distance of all the neighbor pivotal which has already been selected. By ranking according to this weight, the pivotal points can find the road intersections that have not yet converged into the same intersection.

In some embodiments, generating the topological graph map 260 for the road part based on at least one 3D point cloud from the plurality of 3D point clouds in sub-process 265 may include: retrieving a corresponding 3D point cloud for each GPS position from the at least one GPS position associated with the road part; and generating the map for the road part based on the corresponding 3D point cloud for each GPS position from the at least one GPS position.

As an optional step, prior to the sub-process 265, a sub process 259 may first merge two or more road parts from the sub-process 257, when the two or more road parts are sufficiently close to one another. For example, the start point and end point of a first road part may be compared to the start point and end point for a second road part that is close to the first filtered road part (e.g. within 10 meters). All the sufficiently close road parts may be added into a candidate merge list for merging redundant road parts, as further elaborated in FIG. 8 below.

FIG. 8 illustrates an example road part merging process 800 in the sub-process 259 of generating a topological graph map 260, in accordance with some example embodiments. P1, P2, P3 and P4 are pivotal points selected to segment the road 810, 820: road part 810 is defined by P1 and P2, and road part 820 is defined by P3 and P4. By comparing P1 to P3, the sub-process 259 may determine that P1 and P3 are sufficiently close to each other; and by comparing P2 to P4, the sub-process 259 may determine that P2 and P4 are sufficiently close to each other. Therefore, sub-process 259 may determine that P1 can be merged with P3, and P2 can be merged with P4. The distance threshold for merging two pivotal points may be, for example, anywhere from 5 meters to 15 meters. Road part 810 therefore may be merged with road part 820 to form a single road part 810.

When comparing a current road part with one or more road parts in the candidate merge list, a dog walk method may be used to compute the distance of two road parts between two sets of pivotal points. A dog walk method is a method that compares the distance between two arrays. The distance between P1 and P2, and between P3 and P4 is very small.

In some embodiments, road part 820 between P3 and P4 is taken as the road part to build the topological graph map 260, data collected between and including P1 and P3 may be saved as backup map for future use.

In addition, the step to merge the road partition candidates at road intersections may include, as a first step, detecting the intersections according to the curvature based road partition candidates, and marking all the candidates within a radius threshold in normal intersections. An example radius threshold can be 100 meters for large intersections and 20 meters for smaller intersections. Road partition candidates are the pivotal points that are selected (e.g., P3 and P4 from FIG. 8) to form a selected road part.

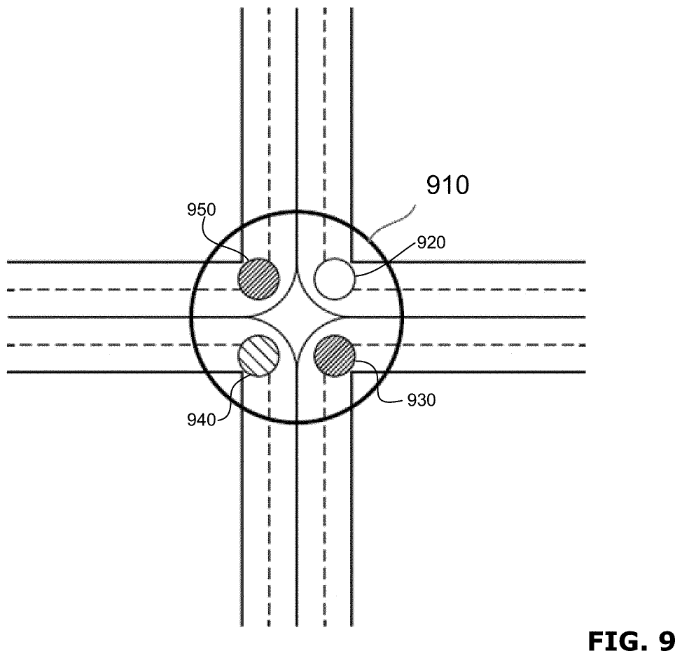

Next, all the road parts that cross the intersections, if the road part has no partition candidate in the intersection, spawning a new partition candidate in the road part. In some embodiments, the nearest pivotal point(s) below a given distance threshold may be deleted to prevent the road part becoming too short. As shown in FIG. 9, an intersection 910 is formed by merging all the pivotal points 920, 930, 940 and 950 generated by sub process 261.

FIG. 6 illustrates an example process of generating bounding boxes 625 based on road parts 605 and 3D point clouds 252, which may be part of sub-process 257 for generating maps based on road parts 605, or part of sub-process 265, for generating a topological graph map 260 from one or more filtered road parts from sub process 259, in accordance with some example embodiments. After road parts 605 are generated (from step 340 in FIG. 3), at step 610, 2D bounding box 615 may be generated for each road part 605 based on a 3D point cloud retrieved for each GPS position within the road part 605, where the 3D point cloud and the GPS position have the same timestamp t. At step 620, elevation data based on one or more altitude values from one or more GPS positions in each road part 605 may be used to generate a 3D bounding box 625 for the respective road part 605. At step 630, each 3D bounding box 625, represented as N1, N2, N3 . . . N12, may be associated with a level based on its respective elevation data. N1, N2, N3 . . . N12 may also refer to the road parts 605 underneath the 3D bounding boxes 625. In some embodiments, in each road part 605, multiple 3D bounding boxes 625 may be generated, based on multiple 3D point clouds associated with multiple GPS positions in the road part 605. For each road part 605, the multiple 3D bounding boxes 625 may be compressed into one image, e.g., an image in the Portable Network Graphic (PNG) format (referred to as PNG image). Each PNG image may be stored in association with a node of the topological graph map 260.

FIG. 7 illustrates an example topological graph map 260 having two levels 710, 720 and a corresponding file format (e.g. PNG image) 730. Each level 710, 720 has edges 715 connecting the road parts N1, N2, N3 . . . N12. The edges 715 which connect the road parts in the graphs are consecutive connections and the intersections, thus can be represented in adjacency table 730.

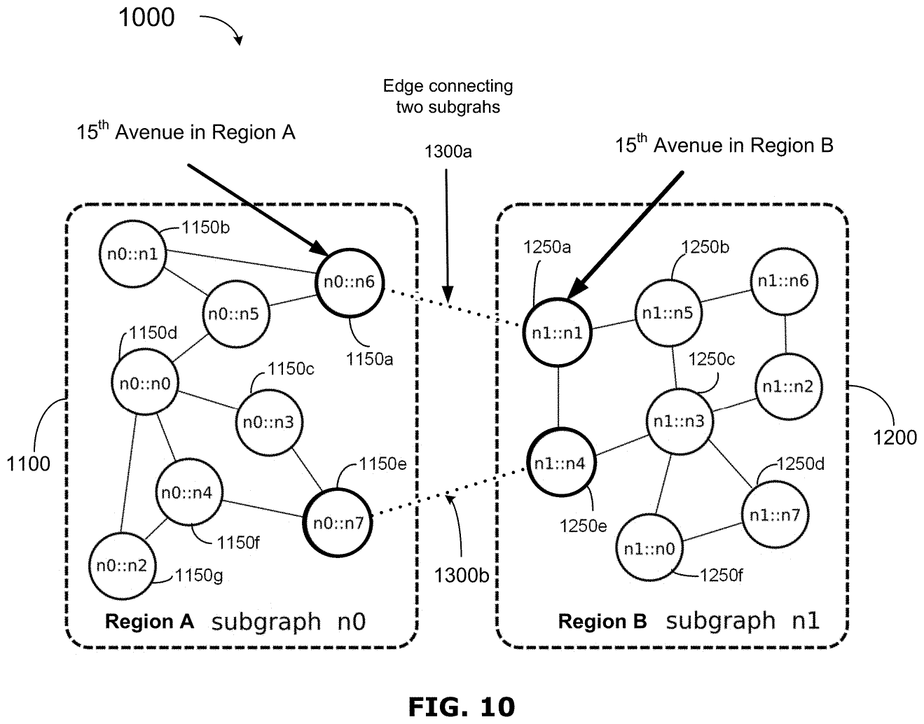

As mentioned earlier, existing 2D voxelized maps cannot adequately represent multi-story structures, and an existing 3D map representing a large area require a computing system with a large amount of storage space for storing the 3D map and a significant amount of processing power to process 3D map. Neither is suitable for representing a large-scale area spanning multiple regions with multi-story buildings for use in localization and/or navigation by autonomous vehicles 100. FIG. 10 illustrates an example large-scale topological graph map 260, in accordance with some example embodiments, that may be used by a vehicle 100 for a task, such as vehicle localization, path planning, motion planning, and trajectory generation. Sub-graph 1100 may be a topological graph map for region A, while sub-graph 1200 may be a topological graph map for region B. Subgraph 1100 may have a number node clusters 1150a, 1150b, 1150c, 1150d, 1150e, 1150f, 1150g, where each node cluster may include one or more nodes, and each node in the one or more nodes may represent a road part in region A. Similarly, subgraph 1200 may have a number node clusters 1250a, 1250b, 1250c, 1250d, 1250e, 1250f where each node cluster may include one or more nodes, and each node in the one or more nodes may represent a road part in region B. The edge 1300a connecting two subgraphs 1100, 1200 may be a major road connecting a node in node cluster 1150a to a node in node cluster 1250a, while the edge 1300b connecting two subgraphs 1100, 1200 may be major road connecting a node in node cluster 1150e to a node in node cluster 1250e.

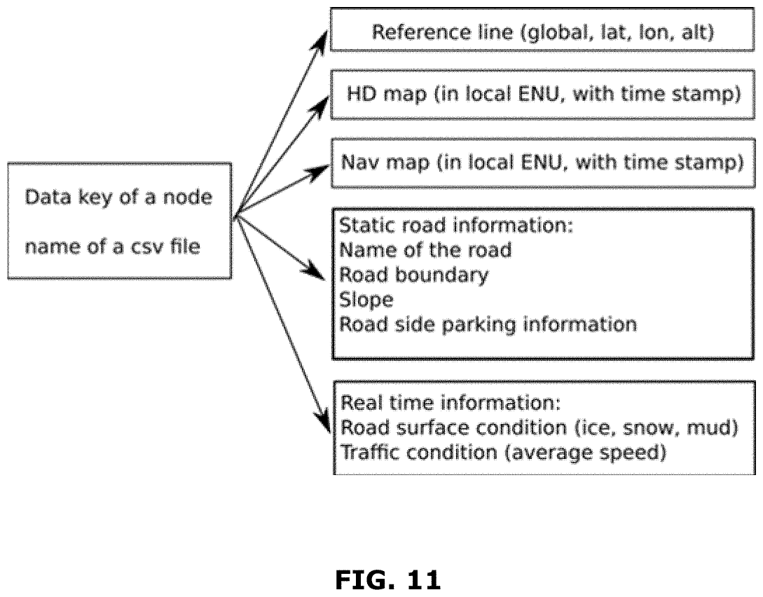

In some embodiments, each road part may be represented by a node that includes a link to a package (i.e. a collection of software) that includes one or more PNG images, trajectory reference lines, land markers and/or road part dimensions. Other information like the road condition and road speed limits can be included as well. For example, FIG. 11 shows an example data structure) for storing a node of the topological graph. The data structure may be used to store information for each road part N1, N2, N3 . . . N12 (nodes) in the topological graph map 260. A data structure is stored as a file, such as a csv file, and the file may include one or more types of information relevant to the node. The file may contain, for example, one or more of: a GPS position associated with the road intersection or turn, a pointer or reference to a HD map oriented in local ENU (East North Up) coordinates with a timestamp, a pointer or reference to a navigation map oriented in local ENU (East North Up) coordinates with a timestamp, static road information (e.g., road name, road boundary, road slope, roadside parking information), and real time information relevant to the node, such as road surface condition or traffic condition.

One or more map tiles can be cut into different sizes according to a respective road part size, and can be loaded dynamically based on the current position of the vehicle 100. A map tile can be an image in a Portable Graphics Format (PNG) file format generated from multiple point clouds and then categorized into the same road part. Rather than loading nine adjacent tiles at once, in some embodiments, the dynamic loading process only loads the maps of the connected road parts into memory 126 of the vehicle 100, making the map loading process more efficient and less dependent on real time GPS signals. The maps (e.g., the PNG images) at the nodes of the topological graph map may also cache the second degree of connections in the background. For example, when the vehicle 100 leaves a current node or road part, some nodes or road parts may then be loaded, while some nodes or road parts may be removed according to the topological graph map 260.

For example, when the vehicle 100 enters into each road part in the topological graph map 260, the ADS 162 can rely on the local coordinates and localization measurements to reduce query of the GPS signals. Local coordinates refer to offset coordinates computed based on odometry data received from the wheel odometer 117 and/or IMU 118 of the vehicle 100. Localization measurements refer to non-GPS measurements obtained using methods such as LIDAR odometry and mapping (LOAM), visual odometry, or visual inertial odometry.

A second level cache technique within the topological graph map 260 offers extra safety when the vehicle localization module 164 is executing a localization algorithm and GPS signals are temporarily unavailable while keeping a reasonably low memory cost. Optimal map loading strategy can be used to load the maps of the nodes of the topological graph map 260 according to a planned path for the vehicle 100 generated by the planning subsystem 174 of the vehicle 100. The second level cache technique refers to the process, by the vehicle 100 when it has already loaded a map at a node for a current road part (i.e., road part 001) of the topological graph map 260, of first caching a map of a node for a first neighboring road part (i.e., road part 002) of the current road part, and then caching a map of a node for a neighboring road part (i.e., road part 003) of the first neighboring road part (road part 002) based on a direction the vehicle 100 is traveling.

In some embodiments, a method of using a topological graph map 260 for vehicle localization may include: receiving a first real-time GPS position of the vehicle; loading a map for a current road part from a node of the topological graph map 260 based on the first real-time GPS position; determining a second map for a second road part based on the first real-time GPS position and a traveling direction of the vehicle; receiving a second real-time GPS position of the vehicle; and loading the second map for the second road part based on the second real-time GPS position of the vehicle, the second map loaded from a second node of the topological graph map 260.

The topological graph map 260 of the present disclosure is much smaller (i.e., requires less memory for processing and storage) than any existing map. For example, the topological graph map 260 may only need memory storage space of 300 KB per 100×100 meters, which makes easily downloaded by a computing system (e.g. the vehicle controller 115) of the vehicle 100 or transferred to the vehicle controller 115 via a cellular data network.

Unlike conventional 2D vehicle localization methods which tend to require high frequency 3D position queries and attitude determination to obtain a portion of a 3D map to be used for localization of the vehicle 100, the topological graph map 260 of the present disclosure, when used during operation of the vehicle 100, only requires query when the preloaded topological graph map is expiring and when a new topological graph map is required.

The topological graph map 260 uses a 2D map format to represent 3D road networks, and can be safely extended to any currently 2D maps in use, such as Google Maps™.

The topological graph map 260 can be used by automatous vehicles or robots to perform a task, such a vehicle localization, path planning, motion planning, or trajectory generation for the autonomous vehicle or robot. With suitable modification, the topological graph map 260 can be used by unmanned vehicles for various tasks. Various types of unmanned vehicles may use the topological graph map 260 for a task, such as localization of the unmanned vehicle, path planning, motion, or trajectory generation for the unmanned vehicle. An unmanned vehicle may send compact feature data of an observed point cloud together with the position of the unmanned vehicle to a computing system via a communication network for updating the topological graph map. The computing system can use the compact feature data and the GPS position of the vehicle 100 to detect a change in the environment surrounding the vehicle 100, and use the compact feature data to update the topological graph map 260. In some embodiments, the vehicle localization module 164 of the vehicle 100 can use the compact feature data to update the topological graph map 260.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method of generating a topological graph map, comprising:
receiving a plurality of Global Positioning System (GPS) positions representing a plurality of locations of a vehicle along a travelled path of the vehicle, each of the plurality of GPS positions representing a respective location from the plurality of locations of the vehicle along the travelled path and associated with a respective timestamp;
receiving a plurality of three-dimensional (3D) point clouds, each of the plurality of 3D point clouds being a corresponding 3D point cloud of a respective GPS position from the plurality of GPS position and captured at each time the respective GPS position is captured;
generating a plurality of road parts based on the plurality of GPS positions, wherein each road part is associated with at least one GPS position from the plurality of GPS positions;
generating a map for each of the plurality of road parts based on at least one 3D point cloud from the plurality of 3D point clouds; and
generating the topological graph map based on the map for each of the plurality of road parts, the topological graph map comprising a plurality of edges and a plurality of nodes, wherein each node represents a respective road part from the plurality of road parts and each edge represents a connection between two road parts from the plurality of road parts.

2. The method of claim 1, wherein generating the plurality of road parts comprises:
determining a plurality of pivotal points of the travelled path based on the plurality of GPS positions, the plurality of pivotal points including one or more curvature pivotal points and one or more elevation pivotal points; and
determining the plurality of road parts based on the one or more pivotal points.

3. The method of claim 2, wherein determining the plurality of pivotal points comprises:
computing one or more curvature values based on the plurality of GPS positions;
determining one or more peak curvatures based on the one or more curvature values; and
selecting the one or more peak curvatures above a curvature threshold to be the one or more curvature pivotal points.

4. The method of claim 2, wherein determining the plurality of pivotal point comprises determining the one or more elevation pivotal points by finding local maximum and minimum elevation values based on one or more of the plurality of GPS positions.

5. The method of claim 2, wherein determining the plurality of road parts comprises:
computing a respective distance between one or more pairs of adjacent pivotal points from the plurality of pivotal points, the adjacent pivotal points including both curvature and elevation pivotal points;
selecting one or more road segments based on the respective distance between each pair of the one or more pairs of adjacent pivotal points; and
filtering the one or more road segments to obtain the plurality of road parts.

6. The method of claim 5, wherein filtering the one or more road segments comprises selecting the one or more road segments based on a minimum distance threshold.

7. The method of claim 5, comprising generating one or more road intersections based on the one or more one or more road segments.

8. The method of claim 7, further comprising:
generating the plurality of nodes based on the maps for the plurality of road parts; and
generating the plurality of edges based on the one or more road intersections, each road intersection connecting a pair of two road parts from the plurality of road parts.

9. The method of claim 8, wherein generating the map for the road part based on at least one 3D point cloud from the plurality of 3D point clouds comprises:
retrieving a corresponding 3D point cloud for each GPS position from the at least one GPS positions associated with the road part; and
generating the map for the road part based on the corresponding 3D point cloud for each GPS position from the at least one GPS position.

10. The method of claim 9, further comprising compressing corresponding 3D point cloud for each GPS position from the at least one GPS position into a Portable Graphics Format (PNG) image to generate a node of the plurality of nodes in the topological graph map.

11. A system for generating a road map, the system comprising:
a processing unit; and
a memory coupled to the processing unit, the memory storing machine-executable instructions that, when executed by the processing unit, cause the system to:
receive a plurality of Global Positioning System (GPS) positions representing a plurality of locations of a vehicle along a travelled path, each of the plurality of GPS positions representing a respective location from the plurality of locations and associated with a respective timestamp;
receive a plurality of three-dimensional (3D) point clouds, each of the plurality of 3D point clouds being a corresponding 3D point cloud of a respective GPS position from the plurality of GPS positions and captured at each time the respective GPS position is captured;
generate a plurality of road parts based on the plurality of GPS positions, wherein each road part is associated with at least one GPS position from the plurality of GPS positions;
generate a map for each of the plurality of road parts based on at least one 3D point cloud from the plurality of 3D point clouds; and
generate the topological graph map based on the map for each of the plurality of road parts, the topological graph map comprising a plurality of edges and a plurality of nodes, wherein each node represents a respective road part from the plurality of road parts and each edge represents a connection between two road parts from the plurality of road parts.

12. The system of claim 11, wherein the instructions, when executed by the processing unit, cause the system to:
determine a plurality of pivotal points of the travelled path based on the plurality of GPS positions, the plurality of pivotal points including one or more curvature pivotal points and one or more elevation pivotal points; and
determine the plurality of road parts based on the one or more pivotal points.

13. The system of claim 12, wherein the instructions, when executed by the processing unit, cause the system to:
compute one or more curvature values based on the plurality of GPS positions;
determine one or more peak curvatures based on the one or more curvature values; and
select the one or more peak curvatures above a curvature threshold to be the one or more curvature pivotal points.

14. The system of claim 12, wherein the instructions, when executed by the processing unit, cause the system to:
find local maximum and minimum elevation values based on one or more of the plurality of GPS positions.

15. The system of claim 12, wherein the instructions, when executed by the processing unit, cause the system to:
compute a respective distance between one or more pairs of adjacent pivotal points from the plurality of pivotal points, the adjacent pivotal points including both curvature and elevation pivotal points;
select one or more road segments based on the respective distance between each pair of the one or more pairs of adjacent pivotal points; and
filter the one or more road segments to obtain the plurality of road parts.

16. The system of claim 15, wherein filtering the one or more road segments comprises selecting the one or more road segments based on a minimum distance threshold.

17. The system of claim 15, wherein the instructions, when executed by the processing unit, cause the system to:
generate one or more road intersections based on the one or more one or more road segments.

18. The system of claim 17, wherein the instructions, when executed by the processing unit, cause the system to:
generate the plurality of nodes based on the maps for the plurality of road parts; and
generate the plurality of edges based on the one or more road intersections, each road intersection connecting a pair of two road parts from the plurality of road parts.

19. The system of claim 18, wherein the instructions, when executed by the processing unit, cause the system to generate the map for the road part based on at least one 3D point cloud from the plurality of 3D point clouds by:
retrieve a corresponding 3D point cloud for each GPS position from the at least one GPS position associated with the road part; and
generate the map for the road part based on the corresponding 3D point cloud for each GPS position from the at least one GPS position.

20. The system of claim 19, wherein the instructions, when executed by the processing unit, cause the system to:
compress corresponding 3D point cloud for each GPS position from the at least one GPS position into a Portable Graphics Format (PNG) image to generate a node of the plurality of nodes in the topological graph map.
